(19) United States
(12) Patent Application Publication
(10) Pub. No.: US 2008/0069542 A1
(43) Pub. Date: Mar. 20, 2008

(54) Still image extracton apparatus, method, and program

(75) Inventor: Toshimitsu Fukushima, Asaka-shi (JP)

Correspondence Address: BIRCH STEWART KOLASCH & BIRCH, PO BOX 747, FALLS CHURCH, VA, 22040-0747, US

(73) Assignee: FUJIFILM CORPORATION

(21) Appl. No.: 11/902,004

(22) Filed: Sep. 18, 2007

(30) Foreign Application Priority Data
Sep. 19, 2006 (JP) 252449/2006

(51) Int. Cl. H04N 5/00

(52) U.S. Cl. 386/121; 386/E05.001

(57) ABSTRACT

In order to extract a still image from a motion image in relation to music included in the motion image, structural information indicating a structure of music included in a motion image read in by an image read-in unit is obtained by a structural information obtaining unit. A timing for extracting a still image representative of the motion image is set by a timing setting unit based on the structural information and a predetermined image extraction parameter. Then, a frame corresponding to the determined timing is extracted by an extraction unit as the still image.

### BACKGROUND OF THE INVENTION

1. Field of the Invention

The present invention relates to a still image extraction apparatus and method for extracting a still image from a motion image, and a program for causing a computer to execute the still image extraction method.

2. Description of the Related Art

Still image extraction from motion images is performed in order to use the extracted still images on commercial product packages and labels, such as DVDs including the motion images therein and the like, after adding various letters and designs thereto, or to use them as chapter lists. For this reason, various methods for extracting still images from motion images are proposed. For example, a method in which a characteristic amount, such as sound level, amount of movement, complexity, or color component included in each frame of a motion image is calculated, and a frame with a maximum characteristic amount is extracted as the still image is proposed as described, for example, in Japanese Unexamined Patent Publication No. 2003-298983. Another method in which a still image is extracted every time the movement of a motion image exceeds a predetermined threshold value is proposed as described, for example, in Japanese Unexamined Patent Publication No. 2003-234996.

Still another method is also proposed as described, for example, in Japanese Unexamined Patent Publication No. 2004-194197, in which an observation region is detected from each of still images cut out from a motion image at predetermined time intervals, a comparison is made between the patterns of the observation regions, and a still image with great variation in the observation region is extracted as the image where the scene is changed in the motion image. A further method for generating various images for packages by changing extraction time intervals according to the movement of an object included in a motion image is also proposed as described, for example, in Japanese Unexamined Patent Publication No. (1993)-037893.

In the mean time, motion images, such as movies and promotion videos, include music which is played according to climax of the scenes of motion images. For example, music is played in the climax scene of a movie, in which it is often the case that the most touching part of the music is played in the climax scene in order to make the impressive scene more exciting.

If still images are extracted based on the characteristic amount of frames or the like, as in the conventional methods, from such motion images, including movies and promotion videos, still images are extracted regardless of the music included in the motion images, and the extracted still images are not likely to correspond to the impressive scenes in the motion images.

### SUMMARY OF THE INVENTION

The present invention has been developed in view of the circumstances described above, and it is an object of the present invention to provide a method and apparatus for extracting a still image from a motion image in relation to music included in the motion image.

In a motion image including music, the features of a phrase and the like appearing in the music are synchronized with the motion image, and it is often the case that at the timing when a particular phrase of the music is played, a scene representative of the motion image is played. The present invention has been developed in view of this point.

A still image extraction apparatus of the present invention is an apparatus including:

a structural information obtaining means for obtaining structural information indicating a structure of music included in a motion image;

a timing setting means for setting a timing for extracting a still image from the motion image based on the structural information and a predetermined image extraction parameter; and

an extraction means for extracting a frame of the motion image corresponding to the determined timing as the still image.

The musical structure may include start time of the music in the motion image, types of particular phrase and touching part included in the music, timings when the particular phrase and touching part appear, arrangement of the particular phrase and touching part, and the like.

The image extraction parameter is a parameter for specifying the timing for extracting a still image, number of still images to be extracted, a purpose thereof, and the like, which is predetermined by the operator.

The frame of a motion image corresponding to the determined timing may be a single frame or a plurality of frames before and/or after the determined timing.

In the still image extraction apparatus of the present invention, the extraction means may be a means for extracting a plurality of frames before and/or after the determined timing, and determining a frame having a highest image quality among the plurality of frames as the still image to be extracted.

Further, in the still image extraction apparatus of the present invention, if the image extraction parameter includes a purpose of the still image, the timing setting means may be a means for setting the timing for extracting the still image based also on the purpose of the still image.

Still further, in the still image extraction apparatus of the present invention, the structural information obtaining means may be a means including a music extraction means for extracting music included in the motion image, and a structural information generation means for generating the structural information by extracting a musical structure from the extracted music.

A still image extraction method of the present invention is a method including the steps of:

obtaining structural information indicating a structure of music included in a motion image;

setting a timing for extracting a still image from the motion image based on the structural information and a predetermined image extraction parameter; and

extracting a frame of the motion image corresponding to the determined timing as the still image.

The still image extraction method of the present invention may be provided in the form of a program for causing a computer to execute the method.

According to the present invention, structural information indicating a structure of music included in a motion image is obtained, a timing for extracting a still image from the motion image is set based on the structural information and a predetermined image extraction parameter, and a frame of the motion image corresponding to the determined timing is extracted as the still image. This allows a still image to be extracted from a motion image in relation to music included in the motion image. Further, music is related to an impressive scene of a motion image, so that an impressive scene of a motion image may be extracted as the still image.

Further, a still image having a higher image quality may be obtained by extracting a plurality of frames before and/or after the determined timing, and extracting a frame having a highest image quality among the plurality of frames.

Still Further, a still image appropriate for a purpose of the still image may be extracted by setting the timing for extracting the still image according to the purpose thereof.

### BRIEF DESCRIPTION OF THE DRAWINGS

FIG. 1 is a schematic block diagram of a still image extraction apparatus according to a first embodiment of the present invention, illustrating the construction thereof.

FIG. 2 is a flowchart illustrating a process performed in the first embodiment.

FIG. 3 illustrates a musical structure.

FIG. 4 illustrates timing setting for still image extraction and extraction of a still image in the first embodiment.

FIG. 5 illustrates timing setting for still image extraction when a plurality of image extraction parameters is set.

FIG. 6 is a schematic block diagram of a still image extraction apparatus according to a second embodiment of the present invention, illustrating the construction thereof.

FIG. 7 is a flowchart illustrating a process performed in the second embodiment.

FIG. 8 illustrates extraction of a still image in the second embodiment.

FIG. 9 illustrates timing setting for still image extraction and extraction of a still image in a third embodiment.

### DESCRIPTION OF THE PREFERRED EMBODIMENTS

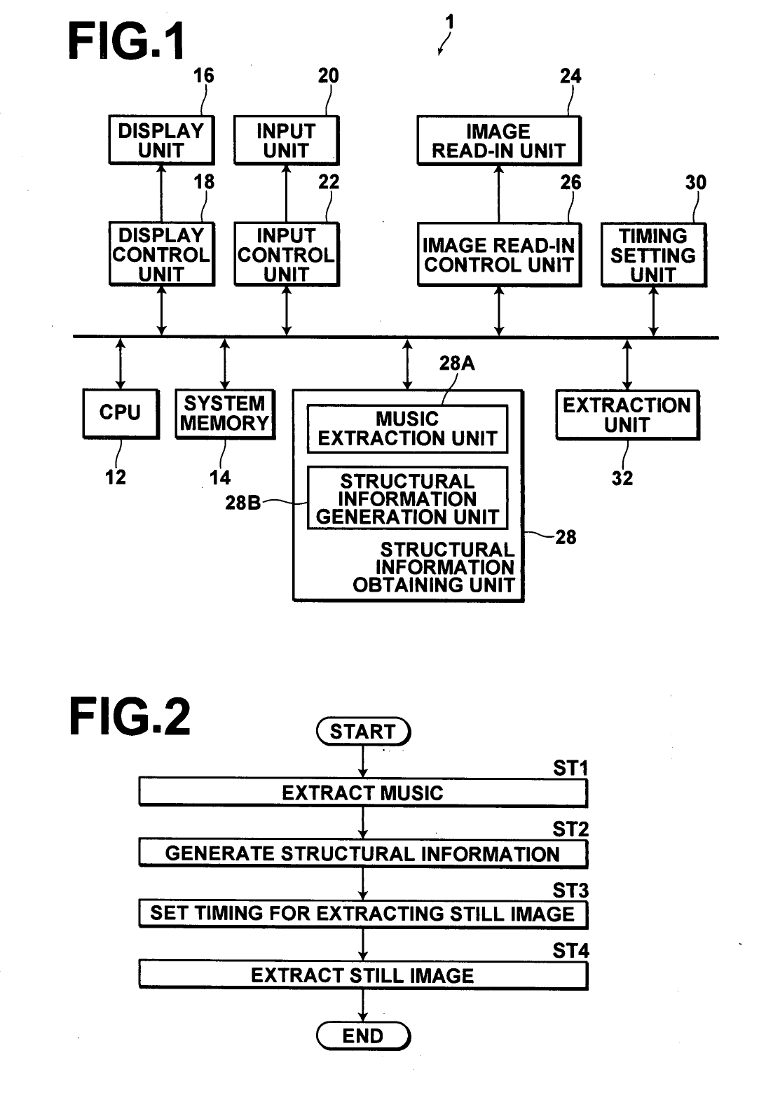

Hereinafter, exemplary embodiments of the present invention will be described with reference to the accompanying drawings. FIG. 1 is a schematic block diagram of a still image extraction apparatus according to a first embodiment of the present invention, illustrating the construction thereof. As illustrated, the still image extraction apparatus 1 according to the present embodiment includes: a CUP 12 that performs various control operations for motion image data representing a motion image, including recording and displaying the motion image, as well as controlling each unit of the apparatus 1; a system memory 14 that includes a ROM in which a program for operating the CPU 12 and various constants are recorded, and a RAM that serves as a work area used by the CPU 12 when performing processing; a display unit 16 that includes a liquid crystal display, or the like, for performing various display operations; a display control unit 18 that controls the display unit 16; an input unit 20 that include a keyboard, a mouse, a touch panel, and the like, for giving instructions to the apparatus 1; and an input control unit 22 that controls the input unit 20. Note that the target motion images are those that include music, and motion images that do not include music are out of scope in the present embodiment.

The still image extraction apparatus 1 also includes: an image read-in unit 24 for reading out motion image data from a medium, such as a memory card, or the like, which includes motion image data representing a motion image, and recording motion image data and image data of an extracted still image, described later, in a medium; and an image read-in control unit 26 that controls the image read-in unit 24.

The still image extraction apparatus 1 further includes: a structural information obtaining unit 28 that obtains structural information indicating a structure of music included in a motion image; a timing setting unit 30 that sets timing for extracting a still image based on the structural information obtained by the structural information obtaining unit 28 and an image extraction parameter predetermined by an operator through input unit 20; and an extraction unit 32 that extracts a frame of the motion image corresponding to the determined timing.

The structural information obtaining unit 28 includes; a music extraction unit 28A that extracts music included in a motion image; and a structural information generation unit 28B that generates structural information by extracting a musical structure from the extracted music.

If the motion image is a promotion video or the like, music starts playing at the same time with the motion image. Thus, the music extraction unit 28A may extract the music by extracting sound information from the motion image. On the other hand, if the motion image is a movie or the like, music does not start playing at the same time with the motion image, since music is included in the middle of the motion image as insertion music. If that is the case, the music extraction unit 28A extracts the music by extracting sound information from the motion image, and then extracting musical portion from the extracted sound information. For extracting music from sound information, any known method may be used, such as, for example, a method that separates music data from sound data, representing sound information, through neural network technique, frequency analysis, or the like, as described, for example, in PCT Japanese Publication No. 2005-518560.

Here, the musical structure may include start time of the music, types of particular phrase and touching part included in the music, timings when the particular phrase and touching part appear, and arrangement of the particular phrase and touching part, and the like. The structural information is information that indicates these musical structures. As for the method for obtaining the phrase, for example, a method that detects a phrase based on a silent part of music as described, for example, in Japanese Unexamined Patent Publication No. 9(1997)-090978, a method that detects a phrase based on a chord included in music as described, for example, in Japanese Unexamined Patent Publication No. 2004-184769, or a method that detects a touching part based on a repeated section in music as described, for example, in Japanese Unexamined Patent Publication No. 2004-233965 may be used.

A process performed in the present embodiment will now be described. FIG. 2 is a flowchart illustrating a process performed in the first embodiment. Here, it is assumed that a motion image from which a still image is extracted is already read in by the image read-in unit 24 and stored in the system memory 14. Further, it is assumed that the duration of the motion image used in the present embodiment is five minutes, and the frame rate thereof is 30 fps. In addition, it is assumed that the image extraction parameter is already set by an operator through the input unit 20.

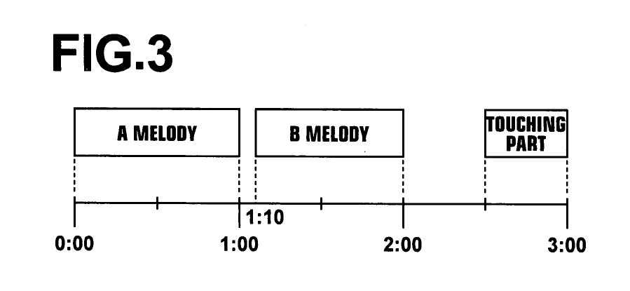

CPU 12 starts processing by receiving an instruction to extract a still image inputted through the input unit 20 by the operator, and music is extracted from the motion image by the music extraction unit 28A of the structural information obtaining unit 28 (step ST1). Then, structural information of the music is generated by the structural information generation unit 28B (step ST2). FIG. 3 illustrates a musical structure. As illustrated, the duration of the extracted music is three minutes, and includes three phrases: “A” melody, “B” melody, and a touching part. “A” melody, “B” melody, and the touching part appear from 0:00 to 1:00, 1:10 to 2:00, and 2:30 to 3:00 respectively in the play time. The extracted music starts playing one minute after the motion image is played. The structural information generation unit 28B generates the start time at which the play of the music is initiated, types of the three phrases, arrangement of the three phrases, and timings when the three phrases appear as the structural information.

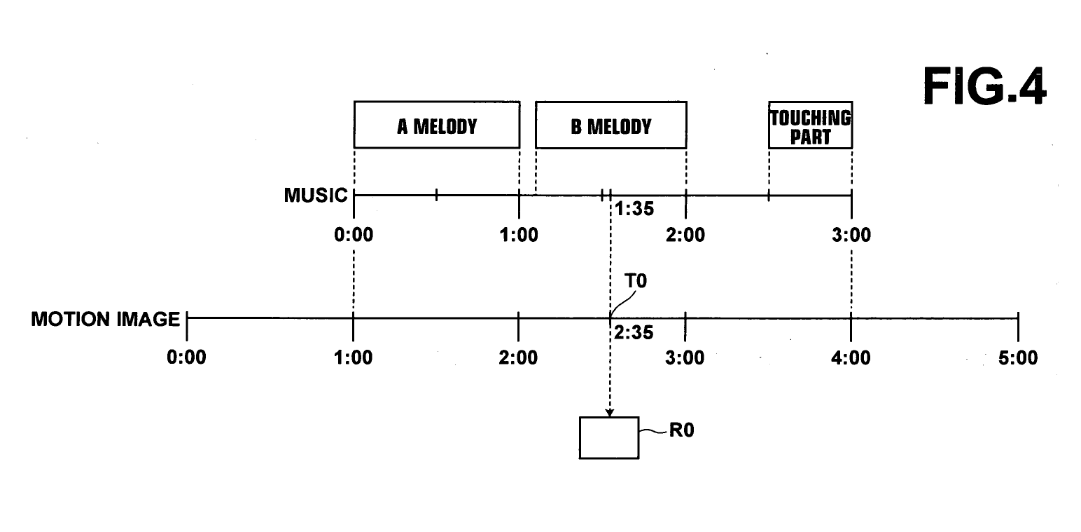

Then, the timing setting unit 30 sets a timing for extracting a still image based on the structural information and image extraction parameter set by the operator (step ST3). FIG. 4 illustrates timing setting for still image extraction and extraction of a still image in the first embodiment. Here, it is assumed that a parameter that specifies one still image be extracted from “B” melody is set as an image extraction parameter P0.

The timing setting unit 30 sets the timings corresponding to the number of still images to be extracted specified by the image extraction parameter P0 as the still image extraction timings. In the present embodiment, the image extraction parameter P0 indicates to extract a single still image from “B” melody, so that the central position of “B” melody is set as the still image extraction timing.

That is, as illustrated in FIG. 4, the music starts playing one minute after the start of the motion image. “B” melody appears between 1:10 to 2:00 in the music play, and the central position appears 1:35 after the start of the music. Accordingly, the timing setting unit 30 sets a still image extraction timing T0 2:35 after the start of the motion image. Timing setting when a plurality of still images is extracted will be described later.

Then, the extraction unit 32 extracts a frame of the motion image corresponding to the still image extraction timing set by the timing setting unit 30 as a still image R0 (step ST4), and the process is terminated. Here, in the present embodiment, the frame rate of the motion image is 30 fps, and the still image extraction timing is 2:35 (155 seconds) after the start of the motion image. Thus, out of 9000 frames (30 fps×5 minutes×60 seconds) included in the motion image, the extraction unit 32 extracts the 4650^{th} frame (30×155) as the still image R0.

As described above, in the present embodiment, a still image extraction timing is set based on structural information of music included in a motion image and a predetermined image extraction parameter, and a frame of the motion image corresponding to the fixed still image extraction timing is extracted as the still image. This allows a still image to be extracted in relation to the music included in a motion image. In particular, an impressive scene in a motion image may be extracted as the still image, since music is played in an impressive scene in a motion image.

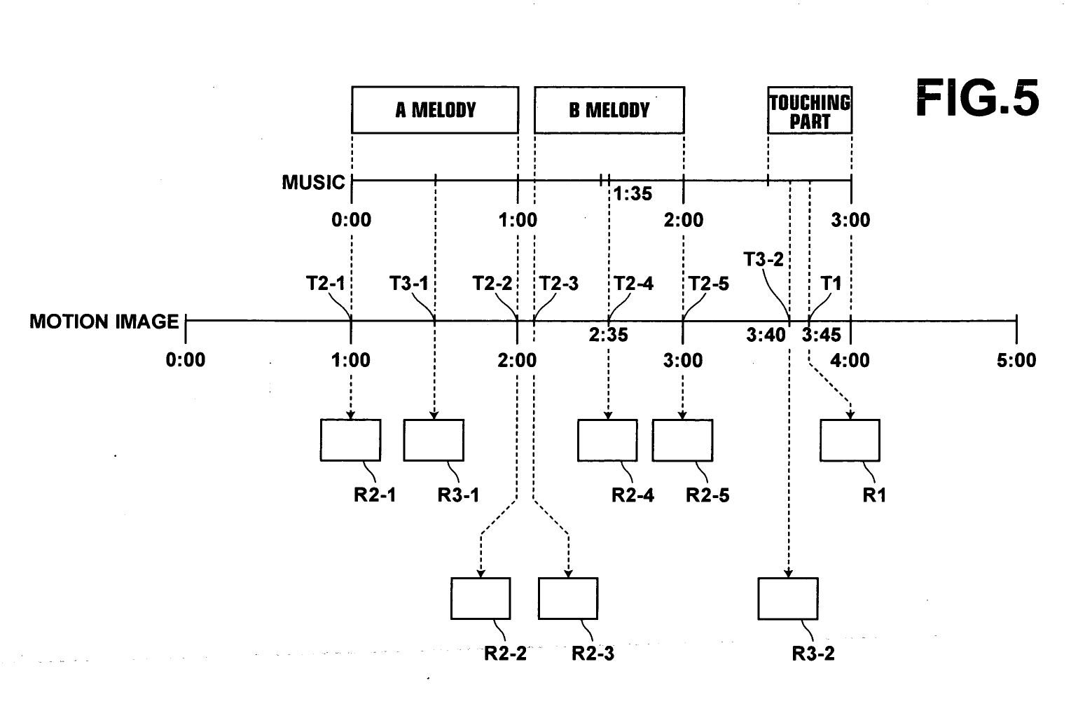

In the present embodiment, only a single image extraction parameter is set, but a plurality of parameters may be set. FIG. 5 illustrates timing setting for still image extraction when a plurality of image extraction parameters is used. Here, it is assumed that the following three image extraction parameters are used: an image extraction parameter P1 specifying that one still image be extracted from the touching part; an image extraction parameter P2 specifying that two still images be extracted from “A” melody and three still images be extracted from “B” melody; and an image extraction parameter P3 specifying that one still image be extracted from the center of “A” melody and a frame locating 10 seconds after the start of the touching part be extracted.

As illustrated in FIG. 5, the music start playing one minute after the start of the motion image. For the image extraction parameter P1 specifying that one still image be extracted from the touching part, the timing setting unit 30 sets the central position of the touching part as a still image extraction timing T1. Here, the touching part appears between 2:30 to 3:00 in the music play, and the central position appears 2:45 after the start of the music. Accordingly, the timing setting unit 30 sets a still image extraction timing T1, based on the image extraction parameter P1, 3:45 (225 seconds) after the start of the motion image. In this case, the frame extracted by the extraction unit 32 as a still image R1 is the 6750^{th} frame (30×225).

In the mean time, for the image extraction parameter P2 specifying that two still images be extracted from “A” melody and three still images be extracted from “B” melody, the timing setting unit 30 sets the beginning and ending of “A” melody as still image extraction timings T2-1, T2-2 respectively, and the beginning, center, and ending of “B” melody as still image extraction timings T2-3, T2-4, T2-5 respectively. Here, “A” melody appears between 0:00 to 1:00 in the music play, and the beginning and ending points appear 0:00 and 1:00 minutes after the start of the music respectively. “B” melody appears between 1:10 to 2:00 in the music play, and the starting point, central position, and ending point appear 1:10, 1:35, and 2:00 after the start of the music respectively.

Accordingly, the timing setting unit 30 sets still image extraction timings T2-1 to T2-5, based on the image extraction parameter P2, 1:00 (60 seconds), 2:00 (120 seconds), 2:10 (130 seconds), 2:35 (155 seconds), and 3:00 (180 seconds) after the start of the motion image respectively. In this case, the extraction unit 32 extracts the 1800^{th} (30×60) frame, 3600^{th} (30×120) frame, 3900^{th} frame (30×130), 4650^{th} (30×155) frame, and 5400^{th} (30×180) frame as still images R2-1 to R2-5 respectively.

For the image extraction parameter P3 specifying that one still image be extracted from the center of “A” melody and a frame locating 10 seconds after the start of the touching part be extracted, the timing setting unit 30 sets the central position of “A” melody and position 10 seconds after the start of the touching part as still image extraction timings T3-1, T3-2 respectively. Here, “A” melody appears between 0:00 to 1:00 in the music play, and the central position appears 0:30 after the start of the music. The touching part appears between 2:30 to 3:00 in the music play, so that the position 10 seconds after the start of the touching position corresponds to 2:40 after the start of the music. Accordingly, the timing setting unit 30 sets still image extraction timings T3-1 and T3-2, based on the image extraction parameter P3, 1:30 (90 seconds) and 3:40 (220 seconds) after the start of the motion image respectively. In this case, the extraction unit 32 extracts the 2700^{th} (30×90) frame, and 6600^{th} (30×220) frame as still images R3-1, R3-2 respectively.

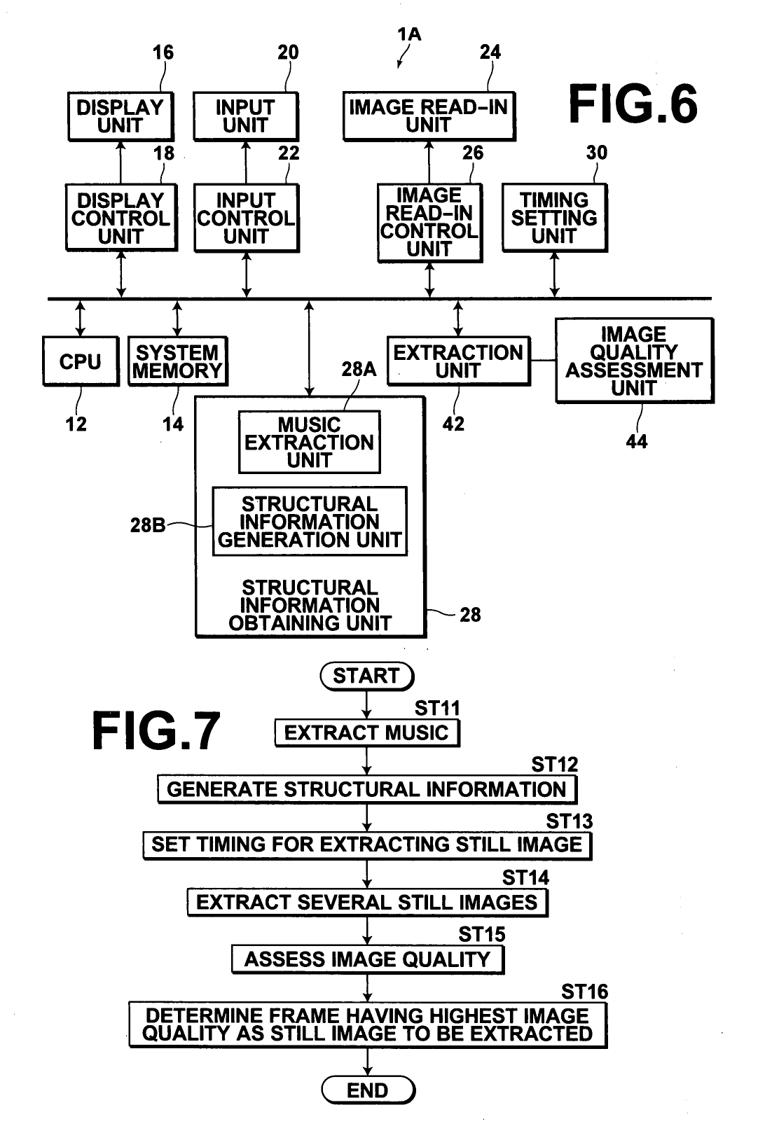

Next, a second embodiment of the present invention will be described. FIG. 6 is a schematic block diagram of a still image extraction apparatus according to a second embodiment of the present invention, illustrating the construction thereof. In the second embodiment, components identical to those in the first embodiment are given the same reference numerals and will not be elaborated upon further here. The still image extraction apparatus 1A according to the second embodiment differs from the first embodiment in that it includes an extraction unit 42 that extracts a frame corresponding to a still image extraction timing set by the timing setting unit 30 and a plurality of frames before and after thereof; and an image quality assessment unit that assesses the quality of the plurality of frames extracted by the extraction unit 42 instead of the extraction unit 32 in the first embodiment.

FIG. 7 is a flowchart illustrating a process performed in the second embodiment. In the flowchart shown in FIG. 7, processing performed in steps S11 to S13 are identical to the processing performed in the steps ST1 to ST3 in the first embodiment, and will not be elaborated further upon here. In the second embodiment, it is assumed that a parameter specifying that one still image be extracted from “B” melody is set as an image extraction parameter P0, as in the first embodiment.

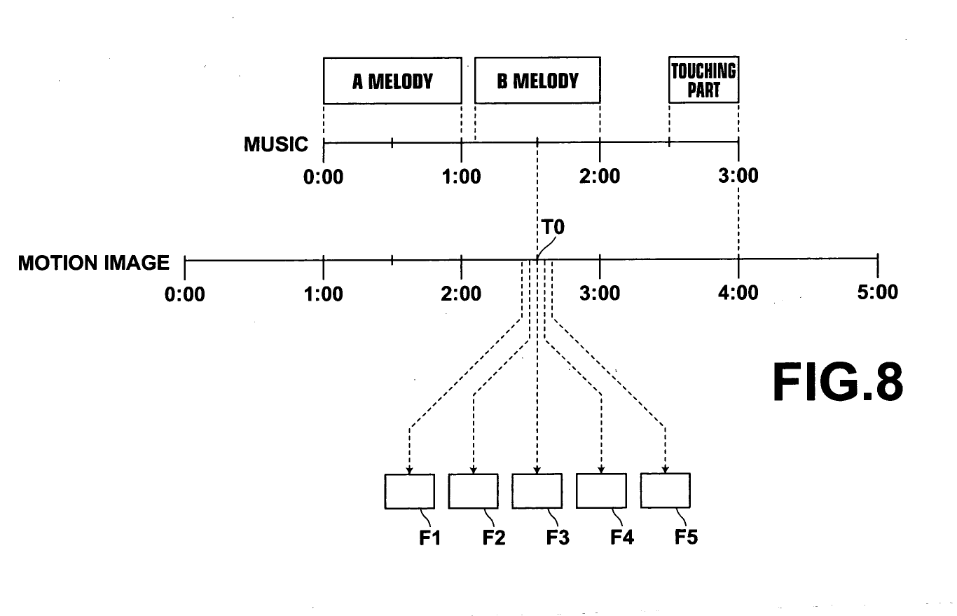

The extraction section 42 extracts a frame corresponding to a still image extraction timing T0 set by the timing setting unit 30 and a plurality of frames before and after thereof (step ST14). FIG. 8 illustrates extraction of a still image in the second embodiment. It is assumed that the still image extraction timing T0 is set 2:35 after the start of the motion image by the timing setting unit 30, as in the first embodiment.

The extraction section 42 extracts a frame corresponding to the still image extraction timing T0 set by the timing setting unit 30 and two frames before and after the frame respectively (totaling five frames) from the motion image. Here, in the present embodiment, the frame rate of the motion image is 30 fps, and the still image extraction timing T0 set by the timing setting unit 30 is 2:35 (155 seconds) after the start of the motion image. Accordingly, five frames F1 to F5, with the 4650^{th} (30×155) frame in the center, are extracted by the extraction unit 42.

Then, the image quality assessment unit 44 assesses the image quality of the frames F1 to F5. More specifically, it assesses image shake and blurry levels by assessing the edge sharpness of the images, and further assesses brightness of the images by assessing density values thereof. Further, an arrangement may be made in which a spatial frequency distribution of an image represented by the frame is measured using the method described in Japanese Unexamined Patent Publication No. 2000-298300 to detect a direction in which the declining rate of high frequency distribution is maximum to estimate the direction as the camera shake direction, and further the autocorrelation function of the image is taken in the estimated camera shake direction, which is then differentiated in the estimated camera shake direction to detect the distance between the local minimum points, thereby image shake level is estimated to assess the image shake. Note that the image quality assessment method is not limited to the method described above, and any of known methods may be used, including a method for assessing only image shakes and blurs, a method for assessing only image brightness, and the like.

Then, the image quality assessment unit 44 determines a frame having a highest image quality, that is, a frame having highest brightness with least amount of image shake and blur, as a frame to be extracted as the still image from the five frames F1 to F5 (step ST16), and the process is terminated.

In this way, the second embodiment may obtain a still image having a higher image quality.

In the second embodiment, five frames are extracted with the frame corresponding to the still image extraction timing set by the timing setting unit 30 in the center, but the number of frames to be extracted is not limited to this. Further, the frames to be extracted are only those either before or after the timing set by the timing setting unit 30. Still further, an arrangement may be made in which the number of frames to be extracted is set by the operator through the input unit 20.

In the first and second embodiments, a purpose of a still image to be extracted may be set as an image extraction parameter, which will be described as a third embodiment of the present invention. The still image extraction apparatus according to the third embodiment is identical to the still image extraction apparatus 1, so that further description of the apparatus is not provided here.

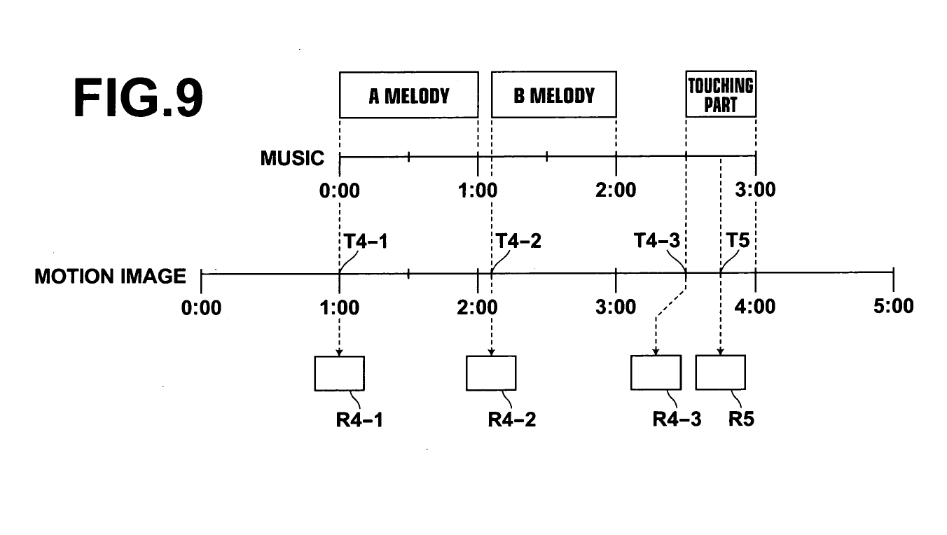

FIG. 9 illustrates timing setting for still image extraction and extraction of a still image in the third embodiment. Here, it is assumed that the structure of the music is identical to that in the first embodiment. In the third embodiment, it is assumed that, with an intention to record a motion image on a DVD for sale, three images for the chapter list of the motion image, one image for the jacket and recording medium face are extracted, which are set in image extraction parameters P4 and P5 respectively. It is also assumed, in the third embodiment, that a table indicating the relationship between a purpose of a still image and a method for setting the still image extraction timing for the purpose is registered in the system memory 14 in advance. More specifically, it is registered in the table that a frame corresponding to the beginning of a phrase be used as the still image extraction timing for an image used for the chapter list, and a frame corresponding to the central position of the touching part of a phrase be used as the still image extraction timing for an image used for the jacket and recording medium face. Note that the table may be a table editable in content by the operator.

First, for the three images used for the chapter list, the timing setting unit 30 sets starting positions of “A” melody, “B” melody and the touching part included in the music as still image extraction timings T4-1 to T-3 based on the image extraction parameter P4 with reference to the table registered in the system memory 14. Here, “A” melody appears between 0:00 to 1:00, “B” melody appears between 1:10 to 2:00, and the touching part appears between 2:30 to 3:00 in the music play. The extracted music starts playing one minute after the start of the motion image. Accordingly, the timing setting unit 30 sets the still image extraction timings T4-1 to T4-3, 1:00 (60 seconds), 2:10 (130 seconds), and 3:30 (210 seconds) after the start of the motion image respectively. In this case, the extraction unit 32 extracts the 1800^{th} (30×60) frame, 3900^{th} (30×130), and 6300^{th} (30×210) frame as still images R4-1, R4-2, and R4-3 respectively.

For the image used for the jacket and recording medium face, the timing setting unit 30 sets central position of the touching part included in the music as a still image extraction timing T5 based on the image extraction parameter P5 with reference to the table registered in the system memory 14. Here, the touching part appears between 2:30 to 3:00 in the music play, so that the central position appears 2:45 after the start of the music. The extracted music starts playing one minute after the start of the motion image. Accordingly, the timing setting unit 30 sets the still image extraction timing T5 3:45 (225 seconds) after the start of the motion image. In this case, the extraction unit 32 extracts 6750^{th} (30×225) frame as still image R5.

In this way, by setting the still image extraction timing according to a purpose of a still image, an image appropriate for the purpose thereof may be obtained.

In the embodiments described above, there may be a case in which a physically impossible image extraction parameter is set through the input unit 20. For example, there may be a case in which an image extraction parameter specifying that 1000 still images be extracted from the touching part of music lasting 30 seconds (900 frames) included in a 30 fps motion image. Here, an arrangement may be made in which an error is displayed on the display unit 16 to prompt the operator to reenter a possible image extraction parameter in such a case.

Further, in the embodiments described above, music is extracted from a motion image, and structural information of the extracted music is generated. But, there may be a case in which a motion image is formed of an image file and a scenario file including the timing of music play. In such a case, structural information indicating the structure of music included in a motion image may be obtained by setting the scenario file without using the music extraction unit 28A and structural information generation unit 28B in the embodiments described above. This may reduce the calculation time for extracting a still image.

So far, apparatuses 1 and 1A according to the embodiments of the present invention have been described. A program for causing a computer to function as the means corresponding to the structural information obtaining unit 28, timing setting unit 3, and extraction units 32, 42, thereby causing the computer to execute the process illustrated in FIGS. 2 and 7 is another embodiment of the present invention. Further, a computer readable recording medium on which such program is recorded is still another embodiment of the present invention.

What is claimed is:

1. A still image extraction apparatus, comprising:
a structural information obtaining means for obtaining structural information indicating a structure of music included in a motion image;
a timing setting means for setting a timing for extracting a still image from the motion image based on the structural information and a predetermined image extraction parameter; and
an extraction means for extracting a frame of the motion image corresponding to the determined timing as the still image.

2. The still image extraction apparatus according to claim 1, wherein the extraction means is a means for extracting a plurality of frames before and/or after the determined timing, and determining a frame having a highest image quality among the plurality of frames as the still image to be extracted.

3. The still image extraction apparatus according to claim 1, wherein, if the image extraction parameter includes a purpose of the still image, the timing setting means is a means for setting the timing for extracting the still image based also on the purpose of the still image.

4. The still image extraction apparatus according to claim 2, wherein, if the image extraction parameter includes a purpose of the still image, the timing setting means is a means for setting the timing for extracting the still image based also on the purpose of the still image.

5. The still image extraction apparatus according to claim 1, wherein the structural information obtaining means comprises:
a music extraction means for extracting music included in the motion image; and
a structural information generation means for generating the structural information by extracting a musical structure from the extracted music.

6. The still image extraction apparatus according to claim 2, wherein the structural information obtaining means comprises:
a music extraction means for extracting music included in the motion image; and
a structural information generation means for generating the structural information by extracting a musical structure from the extracted music.

7. The still image extraction apparatus according to claim 3, wherein the structural information obtaining means comprises:
a music extraction means for extracting music included in the motion image; and
a structural information generation means for generating the structural information by extracting a musical structure from the extracted music.

8. The still image extraction apparatus according to claim 4, wherein the structural information obtaining means comprises:
a music extraction means for extracting music included in the motion image; and
a structural information generation means for generating the structural information by extracting a musical structure from the extracted music.

9. A still image extraction method, comprising the steps of:
obtaining structural information indicating a structure of music included in a motion image;
setting a timing for extracting a still image from the motion image based on the structural information and a predetermined image extraction parameter; and
extracting a frame of the motion image corresponding to the determined timing as the still image.

10. A computer readable recording medium having a program recorded thereon for causing a computer to execute a still image extraction method comprising the steps of:
obtaining structural information indicating a structure of music included in a motion image
setting a timing for extracting a still image from the motion image based on the structural information and a predetermined image extraction parameter; and
extracting a frame of the motion image corresponding to the determined timing as the still image.
